(19) United States
(12) Patent Application Publication
(10) Pub. No.: US 2008/0223008 A1
(43) Pub. Date: Sep. 18, 2008

(54) Saddle for an Animal

(75) Inventor: Martin Patrick Ryan, Wexford (IE)

Correspondence Address: SUGHRUE MION, PLLC, 2100 PENNSYLVANIA AVENUE, N.W., SUITE 800, WASHINGTON, DC, 20037, US

(73) Assignee: Martin Patrick Ryan, Gorey, County Wicklow (IE)

(21) Appl. No.: 11/997,583

(22) PCT Filed: Aug. 2, 2006
(86) PCT No.: PCT/IE06/00082

§ 371 Date: Feb. 19, 2008

(30) Foreign Application Priority Data
Aug. 2, 2005 (IE) S2005/0516

(51) Int. Cl. B68C 1/10; B68C 3/00

(52) U.S. Cl. 54/44.5; 54/44.4; 54/46.1; 54/47

(57) ABSTRACT

A saddle (1) for a horse comprises a pair of side support panels (4) for engaging in the back of the horse (2) and a seat (8) resiliency carried on the side support panels (4) by a pair of mounting members (10) integrally formed with the seat (8) and the side support panels (4). Side members (5) releasably secured to the side support panels (4) extend downwardly on opposite sides of the animal and are releasably secured by a girth strap (6) extending beneath the belly of the horse. A pair of sweat absorbing pads (22) secured to the underside of the side support panels (4) act to transfer sweat from the back of the horse for evaporation thereof. A seat cover (28) is secured to the seat (8), and straps (32) extending from the seat cover (28) carry stirrups (33).

The present invention relates to a saddle for an animal, and in particular, though not limited to a saddle for a horse.

It is well known that riders of horses seated on saddles known heretofore endure considerable pounding as the horse gallops. This is especially true on rough terrain or if the horse jumps an obstacle, for example, in a show jumping, eventing or endurance competition or in a point to point race over fences. Often beginner riders are deterred from pursuing horse riding as a hobby due to the uncomfortable nature of saddles known heretofore as a result of severe impacting forces experienced while riding. Indeed, these impacting forces may have a detrimental affect on the health of frequent horse riders over time. It is not uncommon for horse riders to suffer repetitive back injuries due to the impacting forces to which they are subjected. Additionally, these impacting forces can result in injuries to a horse, in particular back injuries such as bruising and the like.

As well as the problems of impacting forces resulting from the use of saddles known heretofore, such saddles are also difficult to maintain. Typically saddles known heretofore comprise a plurality of discrete components which are assembled together in a predetermined manner. Such saddles are assembled in a manner with certain components difficult to access making cleaning of the saddle an arduous task. A further drawback of saddles known heretofore is that due to their construction sweat is allowed to build up on the horse's back which can cause the horse discomfort due chaffing as a result of the build up of salt crystals between the saddle and the horse's back.

Stirrups known heretofore suffer from a number of problems. One of the main problems of known stirrups is the danger of a rider's foot failing to disengage a stirrup in the event of a rider being thrown from a horse, which can result in the rider being dragged by the horse over a large distance. This is particularly so in the case of a frightened horse, and over rough terrain can lead to a fatality. Indeed, a fallen rider whose foot has failed to disengage a stirrup can be trampled on by a horse. Additionally, during competition it is not uncommon for a rider's foot to accidentally disengage from the stirrup and precious time can be lost by the rider adjusting the orientation of the stirrup so that the rider's foot can once again engage the stirrup.

There is therefore a need for a saddle which addresses at least some of the drawbacks of the prior art.

The present invention is directed to such a saddle.

According to the invention there is provided a saddle for an animal, the saddle comprising a main support for mounting on and securing to the back of an animal, a seat for supporting a rider on the animal, the seat being resiliently coupled to the main support for absorbing shocks between the main support and the seat.

In one embodiment of the invention the main support comprises a main central member formed by a pair of spaced apart side support panels for engaging the back of the animal adjacent the spine on respective opposite sides thereof.

In another embodiment of the invention a pair of spaced apart mounting members extend from the side support panels for resiliently coupling the seat to the side support panels, and preferably, the mounting members are resilient, and ideally, the mounting members extend between the side support panels and the seat adjacent the front of the saddle, and preferably, the side support panels are resiliently coupled to each other for facilitating movement of the panels relative to each other, for in turn accommodating movement of the back of the animal.

In one embodiment of the invention the side support panels are resiliently coupled to each other by the mounting members and the seat.

Advantageously, the mounting members are retained in spaced apart relationship with each other by the seat, for in turn retaining the side support panels in spaced apart relationship with each other.

In one embodiment of the invention the seat, the side support panels and the mounting members are integrally formed from a single piece of material, and preferably, from a single piece of resilient material.

In another embodiment of the invention the side support panels are resiliently coupled to the seat so that the side support panels diverge outwardly downwardly for accommodating the contour of the animal's back.

In a further embodiment of the invention a side member is secured to each side support panel for extending downwardly therefrom on respective opposite sides of the animal, and preferably, each side member is releasably securable to the corresponding side support panel. Advantageously, a first connecting means is provided for connecting the side members together adjacent the rear of the saddle for retaining the side support panels in spaced apart relationship relative to each other adjacent the rear of the saddle.

In one embodiment of the invention a girth strap is provided for extending beneath the belly of the animal.

In another embodiment of the invention a second connecting means is provided for connecting the respective side members to the girth strap on respective opposite sides of the animal for securing the main support to the animal.

In one embodiment of the invention a damping means is provided for acting between the seat and the respective side support panels for damping vibrations in the seat. Advantageously, the damping means comprises a pair of damping members secured to the respective ones of the side support panels, and preferably, the damping means is releasably securable to the side support panels.

In another embodiment of the invention a sweat absorbing pad having a wicking characteristic is secured to each side support panel for engaging the back of the animal for absorbing and removing sweat therefrom. Advantageously, the wicking characteristic of each sweat absorbing pad is such as to transfer sweat from the back of the animal to respective exposed surfaces of the sweat absorbing pad by capillary action so that the sweat is evaporated therefrom by air passing over the exposed surfaces, and preferably, each sweat absorbing pad is releasably securable to the corresponding side support panel.

In one embodiment of the invention the seat is arcuate in a longitudinal direction relative to the longitudinal direction of the saddle, and preferably, the seat is concave in the longitudinal direction when viewed in plan.

In another embodiment of the invention the seat is of arcuate shape in a transverse direction relative to the transverse direction of the saddle, and advantageously, the seat is convex in the transverse direction when viewed in plan.

In one embodiment of the invention a seat cover is provided for covering the seat, and preferably, the seat cover is releasably securable to the seat for facilitating adjustment of the position of the seat cover relative to the seat in a forward/rearward direction, and preferably, the seat cover is padded.

In another embodiment of the invention a stirrup suspending strap is provided on respective opposite sides of the saddle extending downwardly therefrom, and preferably, the stirrup suspending straps extend downwardly from the seat, and advantageously, the stirrup suspending straps extend from the seat cover on respective opposite sides of the saddle, for distributing the riders weight through the seat to the side support panels for more evenly distributing the weight of the rider across the back of the animal.

In one embodiment of the invention a stirrup is secured to each stirrup suspending strap, and advantageously, each stirrup comprises a housing defining a hollow interior region for receiving a forward portion of the foot of a rider, and preferably, the housing of each stirrup forms a base for engaging a sole of a shoe of the rider, and advantageously, the base extends rearwardly from the housing for engaging the sole of the shoe of a rider forward of the heel thereof for distributing the force between the stirrup and the foot of the rider more evenly over the foot of the rider, and for more securely and accurately locating the foot of the rider in the stirrup.

Advantageously, a strap engaging eye bracket is provided on each stirrup and is located for engaging the corresponding stirrup suspending strap so that the relaxed orientation of each stirrup extends in a general forward rearward direction relative to the saddle for correspondingly accommodating the foot of the rider.

The invention will be more clearly understood from the following description of some preferred embodiments thereof, which are given by way of example only, with reference to the accompanying drawings, in which:

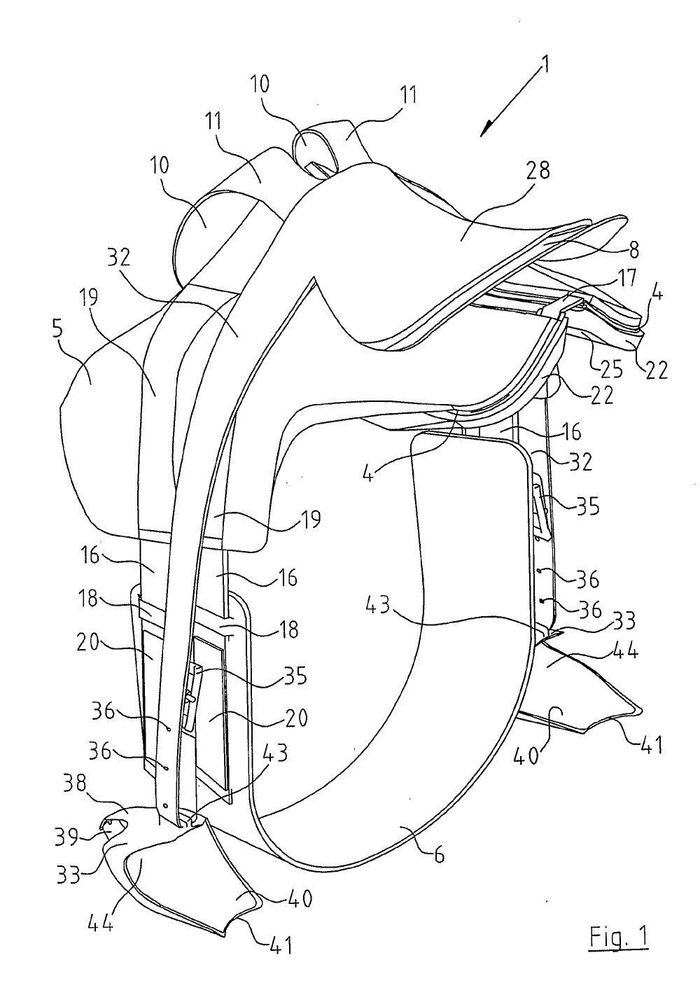

FIG. 1 is a perspective view of a saddle according to the invention,

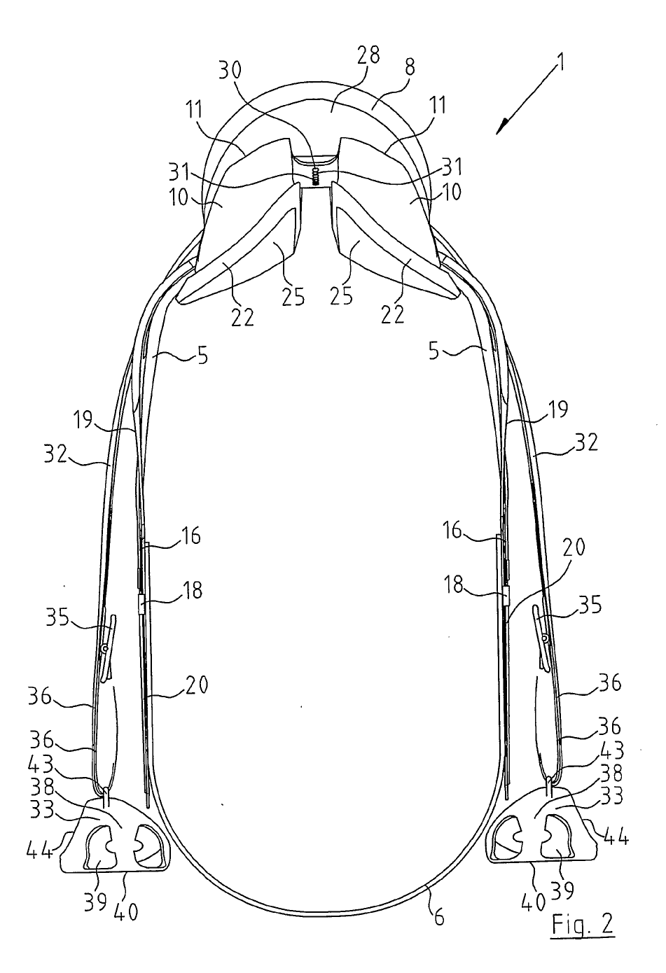

FIG. 2 is a front elevational view of the saddle of FIG. 1,

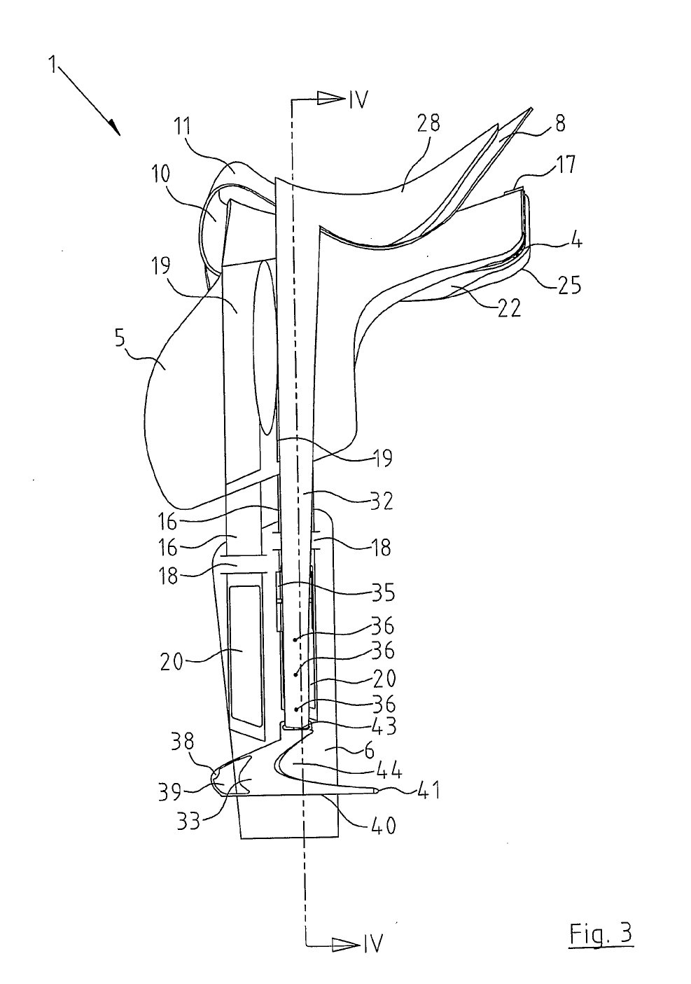

FIG. 3 is a side elevational view of the saddle of FIG. 1,

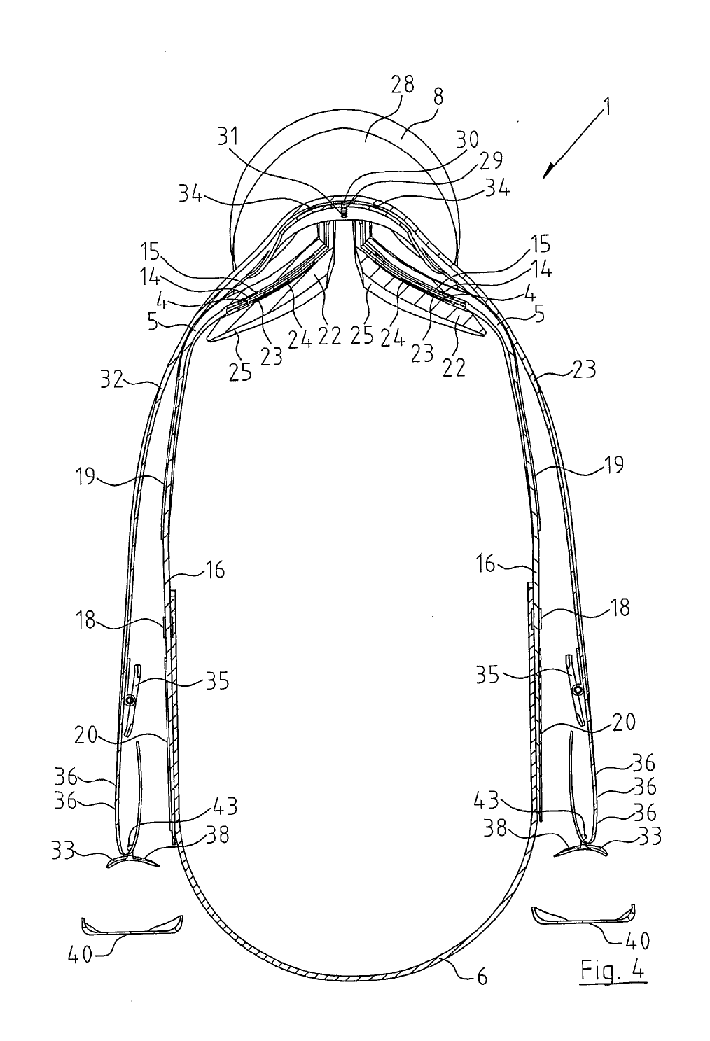

FIG. 4 is a transverse cross-sectional front elevational view of the saddle of FIG. 1 on the line IV-IV of FIG. 3,

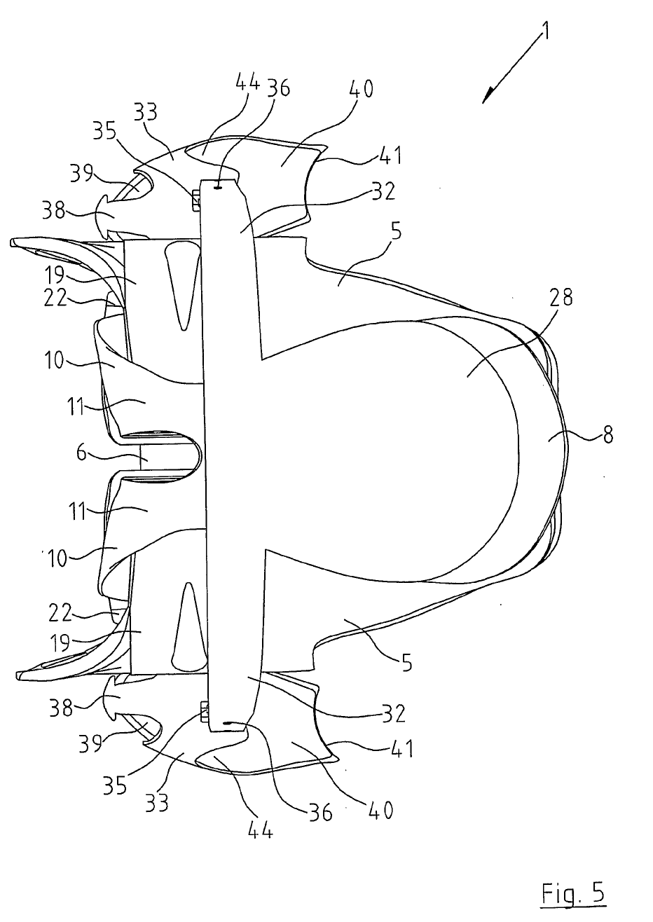

FIG. 5 is a top plan view of the saddle of FIG. 1,

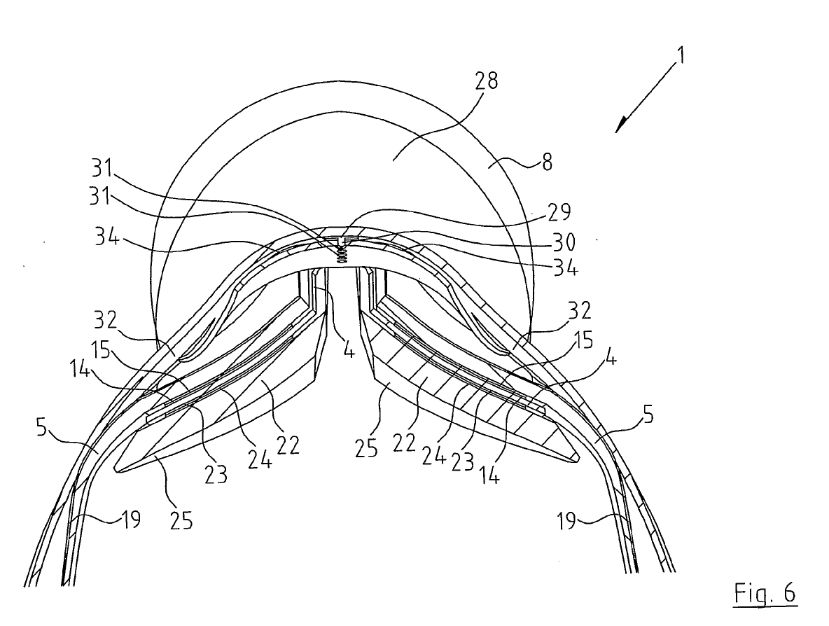

FIG. 6 is a transverse cross-sectional front elevational view of a detail of the saddle of FIG. 1,

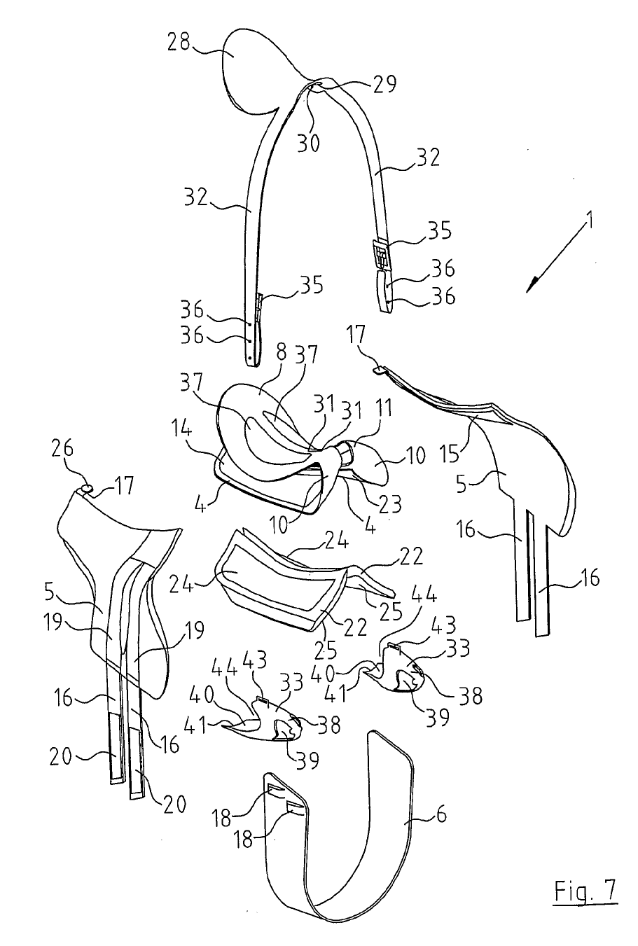

FIG. 7 is an exploded perspective view of the saddle of FIG. 1,

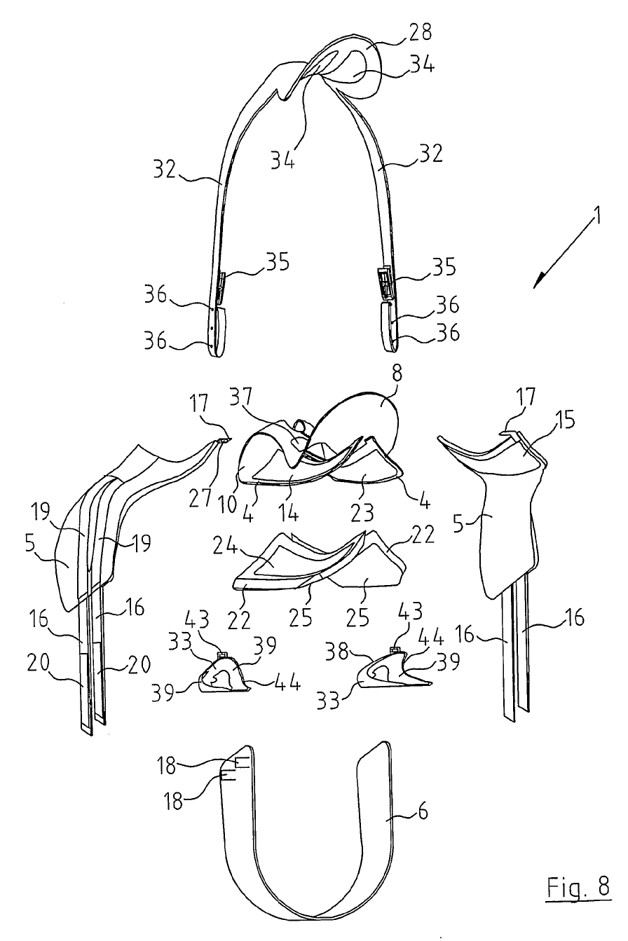

FIG. 8 is another exploded perspective view of the saddle of FIG. 1,

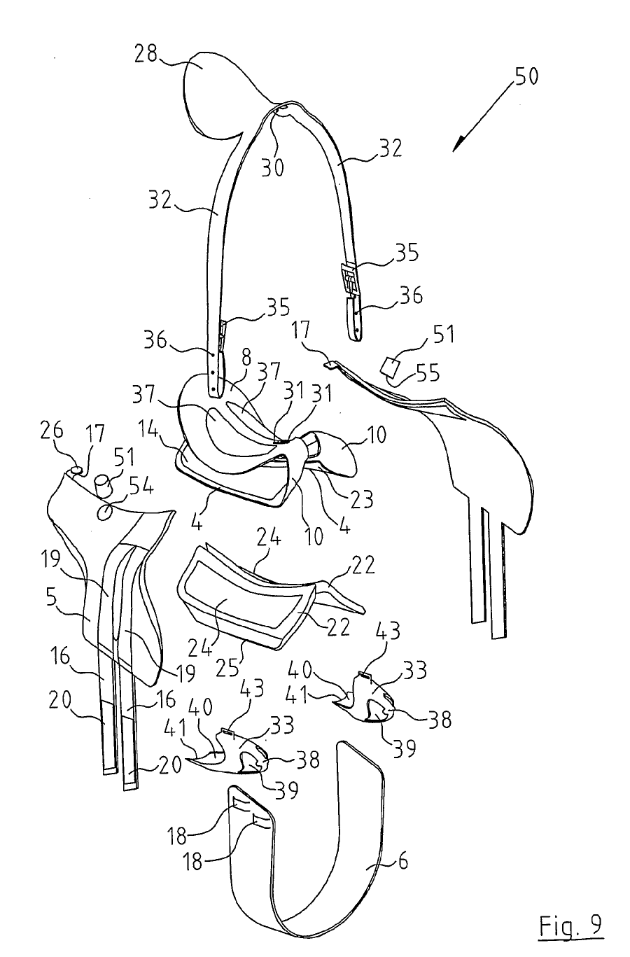

FIG. 9 is a perspective view of a saddle according to another embodiment of the invention, and

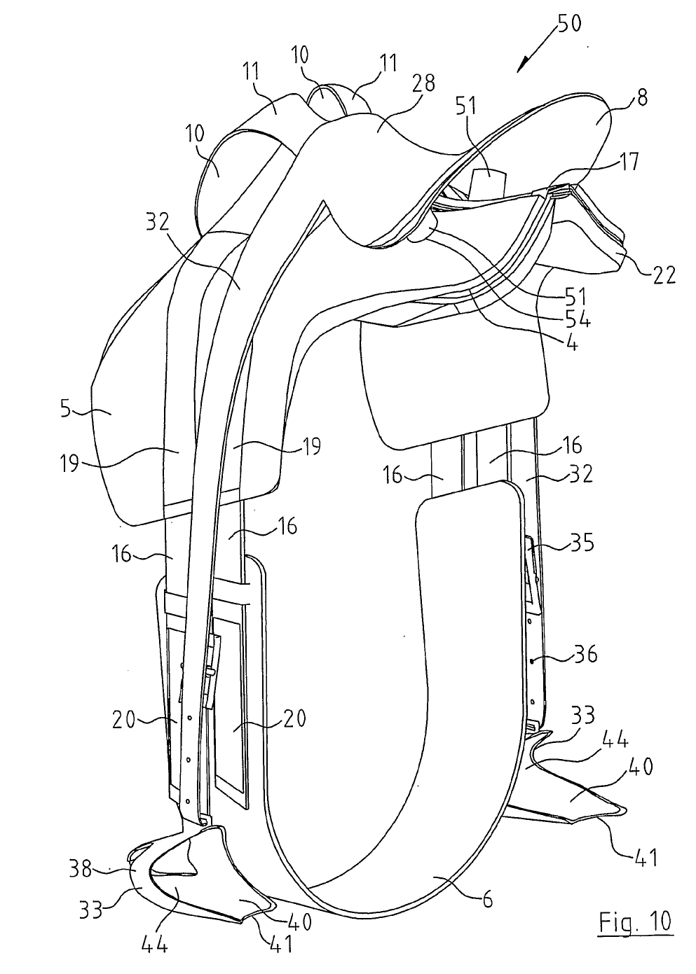

FIG. 10 is an exploded perspective view of the saddle of FIG. 10.

Referring to the drawings and initially to FIGS. 1 to 8, there is illustrated a saddle according to the invention, indicated generally by the reference numeral 1, for an animal, and in this embodiment of the invention the saddle 1 is suitable for a horse. The saddle 1 comprises a main support for mounting the saddle 1 on the horse, which comprises a central member which is formed by a pair of transversely spaced apart side support panels 4 for engaging the back of the horse on respective opposite sides of the spine, a pair of side members 5 releasably secured to the side support panels 4 for extending downwardly on opposite sides of the animal, and a girth strap 6 releasably securable to the side members 5 for extending beneath the belly of the horse, and for securing the saddle 1 to the horse. A seat 8 is resiliently carried on the side support panels 4 by a pair of spaced apart resilient mounting members 10 for absorbing shocks between the side support panels 4 and the seat 8.

In this embodiment of the invention the seat 8, the side support panels 4 and the mounting members 10 are integrally formed from a single piece of layered material, in this embodiment of the invention formed by layers of aramid, carbon fibre, and fibre glass set in an epoxy resin. The material is shaped to form the seat 8 to be concave longitudinally in plan view and convex transversely in plan view. The material is further shaped to form the pair of mounting members 10 which extend downwardly from a front end 11 of the seat 8, and is further shaped to form the side support panels 4. The side support panels 4 are spaced apart to lie on respective opposite sides of the back of the horse adjacent the spine, and are retained in the spaced apart relationship by the mounting members 10, which in turn are retained in spaced apart relationship by the seat 8. The mounting members 10 resiliently couple the side support panels 4 together through the seat 8 for facilitating movement of the side support panels 4 relative to each other, for in turn accommodating movement of the animal's back.

Each side member 5 is formed from one or more panels of closed cell plastics material of the type sold under the trade name Broc encased in a textile material covering, which is die cut and sewn. Each side member 5 is releasably securable to the corresponding side support panel 4 by patches 14 and 15 of hooks and eyes material commonly sold under the Trade Mark VELCRO. The patches 14 are of eyes and are secured by adhesive to the corresponding side support panels 4, while the patches 15 are of hooks and are secured to the side members 5 by stitching, see FIGS. 4, 6, 7 and 8. A first connecting means, in this embodiment of the invention a pair of tabs 17, extend from the side members 5 adjacent the rear thereof and are releasably securable together for retaining the side members 5 together at the rear of the side support panels 4, and for in turn retaining the rear of the side support panels 4 in the spaced apart relationship relative to each other. Patches 26 and 27 of hooks and eyes material similar to the patches 14 and 15 are provided on the tabs 17 for releasably and adjustably securing the tabs 17 together, see FIGS. 7 and 8.

The girth strap 6 is also of Cordura covered Broc material (die cut and sewn), and is releasably secured to the respective side members 5 by second connecting means provided by respective pairs of straps 16 extending downwardly from the respective side members 5. The pairs of straps 16 are sewn onto the corresponding side members 5, and releasably engage closed loops 18 formed on the corresponding ends of the girth strap 6. Patches 19 and 20 of hooks and eyes material, similar to the hooks and eyes material of the patches 14 and 15 are secured to the straps 16 and to the side members 5 for securing the straps 16 to the girth strap 6. In this embodiment of the invention the patches 19 are of hooks and are secured to the side members 5, while the patches 20 are of eyes and are secured to the straps 16. The straps 16 extend downwardly through the loops 18 on the girth strap 6 and are folded about the loops 18 for extending upwardly so that the respective patches 20 land on the corresponding patches 19.

A pair of sweat absorbing pads 22 are releasably secured to the underside of the respective side support panels 4 by patches 23 and 24 of hooks and eyes material similar to the patches 14 and 15. In this embodiment of the invention the patches 23 are of eyes and are secured to the underside of the side support panels 4, while the patches 24 are of hooks and are secured to the sweat absorbing pads 22. Each sweat absorbing pad 22 defines an under surface 25 for engaging the back of the horse, and is of a foam material, for example, an open or closed cell plastics material having wicking characteristics, and in this embodiment of the invention is a closed cell material sold under the trade name Broc, and is similar to that used in the side members 5. The wicking characteristic of the sweat absorbing pads 22 is such as to transfer sweat from the back of the animal to exposed surfaces of the sweat absorbing pads 22 by capillary action, so that air passing the exposed surfaces of the sweat absorbing pads 22 carries the sweat away. This, thus, ensures that the back of the animal remains relatively sweat free, thereby avoiding irritation and chaffing of the animal's back, which would otherwise occur if sweat remained entrapped between a saddle and the back of an animal, which in turn would result in salts in the sweat crystallising, and irritating and chaffing the animal's back.

A padded seat cover 28 is provided for covering the seat 8, and is releasably secured to the seat by a tab 29 extending forwardly from the seat cover, which carries a downwardly extending pin 30 for engaging a selected one of a plurality of corresponding holes 31 in the seat 8. The padded seat cover 28 is also releasably secured to the seat by pads 34 and 37 of hooks and eyes material, similar to the pads 14 and 15 already described. The seat cover 28 comprises one or more pads of Broc material (not shown), which are encased in a textile material cover, which is die cut and sewn.

Stirrup suspending straps 32 extend downwardly from the seat cover 28 on respective opposite sides thereof for carrying stirrups 33 on respective opposite sides of the horse. Each stirrup suspending strap 32 terminates in a buckle 35, and holes 36 in the stirrup suspending straps 32 facilitate adjusting the height of the stirrups 33.

Each stirrup 33 is of injected moulded polycarbonate and comprises a housing 38 which defines a hollow interior region 39 for receiving the corresponding foot of the rider, and an opening 44 to the hollow interior region 39 for accommodating the foot of the rider therethrough. In this embodiment of the invention the housing 38 defines a base 40 for engaging a sole of a shoe of the foot of the rider, and the base 40 extends rearwardly and terminates in an edge 41 which engages the sole of the corresponding shoe of the rider just forward of the heel thereof. A strap engaging eye bracket 43 is provided on the housing 38 of each stirrup 33 for engaging the corresponding stirrup suspending strap 32. The eye bracket 43 of each stirrup 33 extends in a generally forwardly, rearwardly, longitudinal direction relative to the saddle and the horse, so that when the stirrups 33 are suspended by the stirrup suspending straps 32, the stirrups 33 in their relaxed state are presented to the foot of the rider so that the opening 44 to the hollow interior region 39 of each stirrup 33 extends transversely of the saddle and the horse for directly receiving the foot of the rider without having to reorient the stirrups 33 into a riding position. The housing 38 of each stirrup 33 is of sufficient size to extend over a forward portion of the shoe of the rider and over a portion of the instep of the shoe of the rider so that in the event of a rider being toppled from the horse, the feet of the rider readily easily disengage from the corresponding stirrups 33, and there is no danger of a rider being dragged by the horse.

In use, the saddle 1 is assembled by initially securing the pads 22 to the undersides of the corresponding side support panels 4. The side members 5 are then secured to the corresponding side support panels 4, and the tabs 17 are secured together. The seat cover 28 is secured to the seat 8 by engaging the pin 30 extending from the tab 29 in an appropriate one of the holes 31 in the seat 8 to suit the rider. The saddle 1 so assembled is placed on the back of the horse, and the girth strap 6 is offered up under the horse and secured to the side members 5 by the straps 16. The saddle is then tightly secured to the horse by tightening the straps 16. The length of the stirrup suspending straps 32 are then adjusted so that the stirrups 33 are at the desired height for the rider. This adjustment is carried out by engaging the buckle 35 in the appropriate one of the corresponding holes 36 of each stirrup suspending strap 32.

With the saddle so secured to the horse, the horse and saddle are ready for riding.

Referring now to FIG. 9 and FIG. 10 there is illustrated a saddle according to another embodiment of the invention indicated generally by the reference numeral 50. The saddle 50 is substantially similar to the saddle 1 and similar components are identified by the same reference numerals. The only difference between the saddle 50 and the saddle 1 is that the saddle 50 is provided with a damping means which is provided by a pair of resilient cylindrical foam damping members 51 for damping vibrations in the seat 8. The damping members 51 are of polyurethane and are releasably secured to the side members 5 between the side members 5 and the seat 8 for engaging the base of the seat 8. Patches 54 and 55 of hooks and eyes material, similar to the hooks and eyes material of the patches 14 and 15 are secured to the damping members 51 and to the side members 5 for securing the respective damping members 51 to the corresponding side members 5. It is envisaged that pairs of damping members 51 will be provided, and respective pairs of the damping members 51 will be of different resilience for providing different levels of damping. A rider by selecting the pair of damping members 51 of the appropriate resilience can thus determine the level of damping of the seat 8. Use of the saddle 50 is similar to that described with reference to the saddle 1.

The advantages of the saddle according to the invention are many. A particularly important advantage of the saddle is the fact that shocks between the side support panels 4 and the seat 8 are absorbed by the resilient mounting members 10 which couple the seat 8 to the side support panels 4, and are thus not transferred from the side support panels 4 to the seat 8, or if transferred are of considerably reduced force. This minimises discomfort to the horse and to the rider. The side support panels on which the seat is resiliently supported can move resiliently and dynamically relative to each other with movement of the back of the animal. This, facilitates in distributing the weight of the rider more evenly across the back of the animal. By providing the damping pads 51 vibration in the seat can be reduced and in some cases eliminated.

A further advantage of the invention is provided by the fact that the saddle 1 can be readily easily disassembled, and thus, individual components of the saddle can be individually washed or cleaned as appropriate, for example, by machine washing.

A further advantage of the invention is provided by the construction of the stirrups 33, which facilitate ready disengagement of the feet of the rider from the stirrups 33, thereby avoiding any danger of a rider being dragged by a horse. The fact that each stirrup is provided in the form of a housing, and with a base 40 facilitates in securing a foot of the rider in the stirrup, and also facilitates accurately locating the foot in the stirrup. The fact that the forward portion of the stirrup is partially closed prevents the foot sliding forwardly through and out of the stirrup.

A further advantage of the stirrups is provided by the fact that the eye brackets of the stirrups for engaging the stirrup suspending straps extend in a generally forwardly, rearwardly, longitudinal direction relative to the saddle and the horse. This ensures that the stirrups suspended by the stirrup suspending straps when in their relaxed state are presented to the feet of the rider in a riding orientation, with the opening to the hollow interior region of each stirrup extending transversely of the saddle and the horse for directly receiving the foot of the rider without having to reorient the stirrups into the riding orientation.

Another advantage of the saddle according to the invention is that the sweat absorbing pads 22 on the underside of the side support panels by acting to transfer sweat from the back of the animal by capillary action act to maintain the back of the animal relatively dry, thereby avoiding irritation and chaffing of the back of the animal by crystals of salt from the sweat, which would otherwise form between the saddle and the back of the animal if the sweat were not removed from the back of the animal.

While the saddle has been described as being of specific materials, other suitable materials may be used without departing from the scope of the invention. Additionally, while the seat, the side support panels and the mounting members have been described as being formed from a single piece of resilient material, the seat, side support panels and mounting members may be separately formed, and needless to say, any other suitable resilient mounting means for resiliently mounting the saddle to the side support panels may be used. Needless to say, while the main support has been described as being formed by the pair of side support panels, the main support may be formed by a single support panel, instead of the side support panels. While the seat, the mounting members and the side support panels have been described as being of aramid, carbon fibre, and glass fibre, any other suitable materials may be used whether layered or otherwise. Indeed, in certain cases, it is envisaged that the carbon fibre may be set in a polyurethane resin. Additionally, it is envisaged that in certain cases the material of the seat, the mounting members and the side support panels may be transfer moulded.

Needless to say, while the material of the sweat absorbing pads 22, and other pads used in the saddle according to the invention have been described as being of Broc material, the pads may be of any other suitable material, and where the pads are required to have a wicking characteristic, it is envisaged that they will be of suitable open or closed cell plastics or other material. Needless to say, while the textile material of the components of the saddle which require textile material have been described as being of cordura, any other suitable materials may be used.

1-37. (canceled)

38. A saddle for an animal, the saddle comprising a main support for mounting on and securing to the back of an animal, a seat for supporting a rider on the animal, the seat being resiliently coupled to the main support for absorbing shocks between the main support and the seat.

39. A saddle as claimed in claim 38 in which the main support comprises a main central member formed by a pair of spaced apart side support panels for engaging the back of the animal adjacent the spine on respective opposite sides thereof, and a pair of spaced apart mounting members extend from the side support panels for resiliently coupling the seat to the side support panels.

40. A saddle as claimed in claim 39 in which the mounting members are resilient, and preferably, the mounting members extend between the side support panels and the seat adjacent the front of the saddle.

41. A saddle as claimed in claim 39 in which the side support panels are resiliently coupled to each other for facilitating movement of the panels relative to each other, for in turn accommodating movement of the back of the animal, and preferably, the side support panels are resiliently coupled to each other by the mounting members and the seat.

42. A saddle as claimed in claim 39 in which the mounting members are retained in spaced apart relationship with each other by the seat, for in turn retaining the side support panels in spaced apart relationship with each other.

43. A saddle as claimed in claim 39 in which the seat, the side support panels and the mounting members are integrally formed from a single piece of material, and preferably, the single piece of material from which the seat, the side support panels and the mounting members are formed is a resilient material, and advantageously, the side support panels are resiliently coupled to the seat so that the side support panels diverge outwardly downwardly for accommodating the contour of the animal's back.

44. A saddle as claimed in claim 39 in which a side member is secured to each side support panel for extending downwardly therefrom on respective opposite sides of the animal, and preferably, each side member is releasably securable to the corresponding side support panel.

45. A saddle as claimed in claim 44 in which a first connecting means is provided for connecting the side members together adjacent the rear of the saddle for retaining the side support panels in spaced apart relationship relative to each other adjacent the rear of the saddle.

46. A saddle as claimed in claim 44 in which a girth strap is provided for extending beneath the belly of the animal, and preferably, a second connecting means is provided for connecting the respective side members to the girth strap on respective opposite sides of the animal for securing the main support to the animal.

47. A saddle as claimed in claim 39 in which a damping means is provided for acting between the seat and the respective side support panels for damping vibrations in the seat.

48. A saddle as claimed in claim 47 in which the damping means comprises a pair of damping members secured to the respective ones of the side support panels, and advantageously, the damping means is releasably securable to the side support panels.

49. A saddle as claimed in claim 39 in which a sweat absorbing pad having a wicking characteristic is secured to each side support panel for engaging the back of the animal for absorbing and removing sweat therefrom, and preferably, the wicking characteristic of each sweat absorbing pad is such as to transfer sweat from the back of the animal to respective exposed surfaces of the sweat absorbing pad by capillary action so that the sweat is evaporated therefrom by air passing over the exposed surfaces, and advantageously, each sweat absorbing pad is releasably securable to the corresponding side support panel.

50. A saddle as claimed in claim 38 in which the seat is arcuate in a longitudinal direction relative to the longitudinal direction of the saddle, and preferably, the seat is concave in the longitudinal direction when viewed in plan.

51. A saddle as claimed in claim 38 in which the seat is of arcuate shape in a transverse direction relative to the transverse direction of the saddle, and preferably, the seat is convex in the transverse direction when viewed in plan.

52. A saddle as claimed in claim 38 in which a seat cover is provided for covering the seat, and preferably, the seat cover is releasably securable to the seat for facilitating adjustment of the position of the seat cover relative to the seat in a forward/rearward direction.

53. A saddle as claimed in claim 52 in which the seat cover is padded.

54. A saddle as claimed in claim 52 in which a stirrup suspending strap is provided on respective opposite sides of the saddle extending downwardly therefrom, and preferably, the stirrup suspending straps extend downwardly from the seat.

55. A saddle as claimed in claim 54 in which the stirrup suspending straps extend from the seat cover on respective opposite sides of the saddle, for distributing the riders weight through the seat to the side support panels for more evenly distributing the weight of the rider across the back of the animal.

56. A saddle as claimed in claim 54 in which a stirrup is secured to each stirrup suspending strap, and preferably, each stirrup comprises a housing defining a hollow interior region for receiving a forward portion of the foot of a rider.

57. A saddle as claimed in claim 56 in which the housing of each stirrup forms a base for engaging a sole of a shoe of the rider, and preferably, the base extends rearwardly from the housing for engaging the sole of the shoe of a rider forward of the heel thereof for distributing the force between the stirrup and the foot of the rider more evenly over the foot of the rider, and for more securely and accurately locating the foot of the rider in the stirrup, and preferably, a strap engaging eye bracket is provided on each stirrup and is located for engaging the corresponding stirrup suspending strap so that the relaxed orientation of each stirrup extends in a general forward rearward direction relative to the saddle for correspondingly accommodating the foot of the rider.
